(19) United States
(12) Patent Application Publication
(10) Pub. No.: US 2012/0286591 A1
(43) Pub. Date: Nov. 15, 2012

(54) POWER SUPPLY DEVICE

(75) Inventors: Michael Schiemann, Berlin (DE); Ossama Obeidi, Berlin (DE); Peter Birke, Glienicke/Nordbahn (DE); Olaf Boese, Berlin (DE); Bertram Schemel, Berlin (DE)

(73) Assignee: CONTINENTAL AUTOMOTIVE GMBH, HANNOVER (DE)

(21) Appl. No.: 13/520,720

(22) PCT Filed: Dec. 22, 2010
(86) PCT No.: PCT/EP2010/070572

§ 371 Date: Jul. 5, 2012

(30) Foreign Application Priority Data
Jan. 8, 2010 (DE) 10 2010 004 216.1

(51) Int. Cl. H02J 4/00

(52) U.S. Cl. 307/130

(57) ABSTRACT

A power supply device has a power source providing a voltage and a monitoring device electrically connected to the power source. The monitoring device measures the voltage, the current, and the temperature of the power source when power is drawn from the power source, and interrupts the power draw if the voltage drops below a cutoff threshold. The cutoff threshold depends on the temperature at the power source and the current.

The invention relates to a power supply device.

Motor vehicles with a hybrid drive, also referred to as hybrid vehicles, have an internal combustion engine, one or more electric machines and one or more electrochemical energy storage devices, for example. Electric vehicles with fuel cells generally consist of a fuel cell for energy conversion, a tank for liquid or gaseous energy carriers, an electrochemical and/or electrostatic energy storage device and one or more electric machines for driving.

The electric machine of a hybrid vehicle is generally embodied as a starter/generator and/or electric drive. As a starter/generator, it replaces the starter motor and the alternator that are normally present. In the case of embodiment as an electric drive, an additional torque, i.e. an acceleration torque, to drive the vehicle forward can be contributed by the electric machine. As a generator, it allows recuperation of braking energy as electrical energy to the energy storage device and the onboard power supply system.

In the case of a purely electric vehicle, the motive power is made available exclusively by an electric machine. Common to both types of vehicle, namely hybrid and electric vehicles, is the fact that large amounts of electrical energy have to be made available, transferred and stored.

The flow of energy is controlled by means of an electronic system, generally referred to as a hybrid controller. Among other things, this controls whether power should be drawn from or supplied to the energy storage device, and in what quantity.

The power drawn from the fuel cell or the energy storage device is generally used to provide motive power and to supply the onboard electrical system of the vehicle. The supply of power is used to charge the storage device or to convert braking energy into electrical energy, i.e. for regenerative braking. A very wide variety of power sources may be considered as suppliers of power and storage devices, e.g. fuel cells, special capacitors and a wide range of electrochemical elements, in particular of secondary electrochemical elements—storage batteries. It is important here to achieve the best possible balance between volume, weight, service life and costs.

Irrespective of the underlying electrochemistry, the discharge curve of electrochemical elements is typically characterized by 3 phases when power is drawn. The start of current loading (phase 1) is characterized by a virtually instantaneous voltage dip. This is followed by a constant voltage profile with virtually continuous loading (phase 2). A voltage dip at the end of the discharge phase (phase 3) due to depletion of the starting materials as the electrochemical reaction continues characterizes the final discharge and defines the lowest limit of cell discharge, generally known as the cutoff voltage or final discharge voltage (Uₛ). An excessive discharge below the final discharge voltage is considered to be a deep discharge and can lead to increased aging and a premature decline in capacity due to the high loading of the active reaction material.

In general, the practice hitherto has therefore been to specify the final discharge voltage for the respective power source as a constant value in all cases on the basis of expert knowledge. However, although this solution is simple, it is not satisfactory, especially at low temperatures and high discharge currents since the voltage level at low temperatures and high discharge currents is only just above the cutoff voltage owing to the large voltage drop at the start of discharge, and the power that can be drawn is therefore severely limited.

It is the object of the present invention to specify a power supply device having a power source of the type stated at the outset in which these disadvantages do not occur.

The object is achieved by an energy supply device in accordance with patent claim 1. Embodiments and developments of the inventive concept form the subject matter of dependent claims.

The object is achieved, in particular, by a power supply device having a power source providing a voltage and a monitoring device, which is electrically connected thereto, which measures the voltage, current intensity, and temperature at the power source when power is drawn from the power source, and which interrupts the power draw if the voltage drops below a cutoff limit, wherein the cutoff limit depends on the temperature at the power source and/or on the current intensity.

The invention is explained in greater detail below by means of the illustrative embodiments depicted in the figures of the drawing, in which:

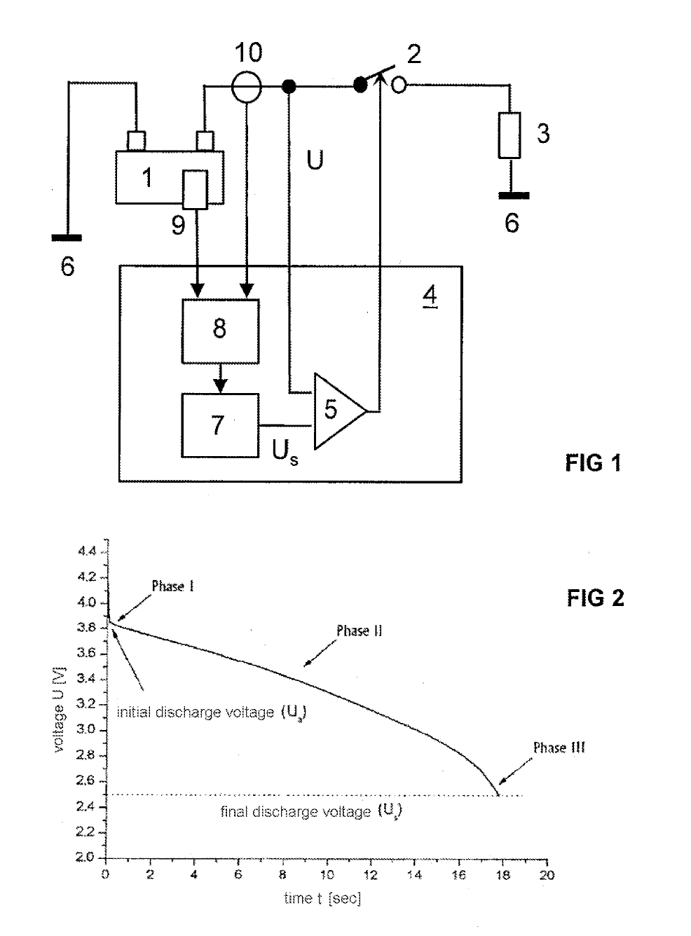

FIG. 1 shows an illustrative structure for an energy supply device according to the invention in a block diagram,

FIG. 2 shows the typical curve profile during the discharge of a battery in a diagram, divided into 3 phases,

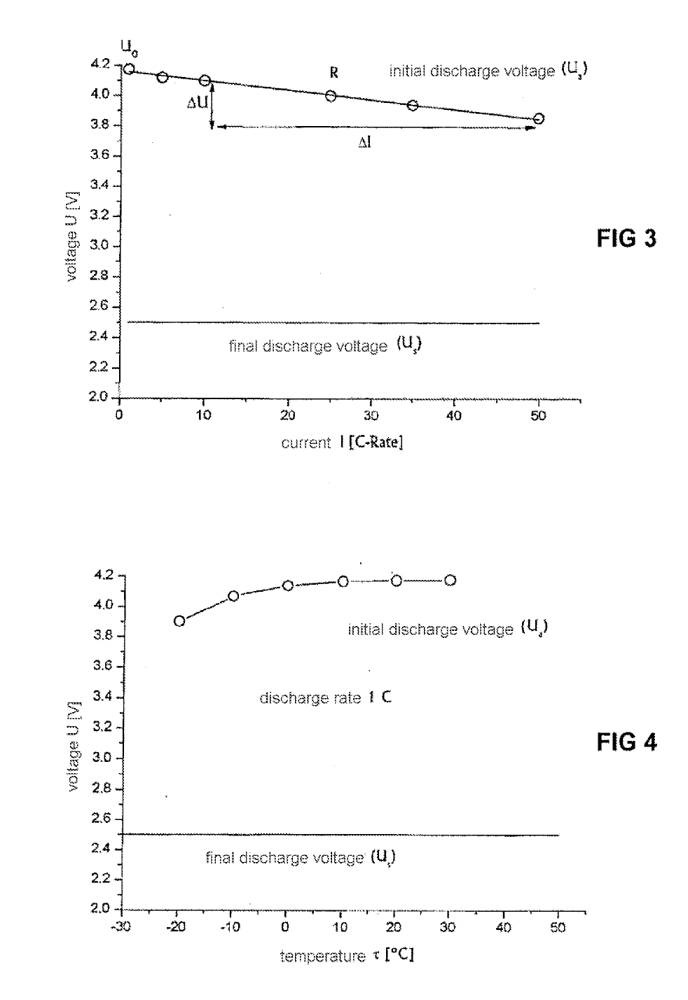

FIG. 3 shows the dependence of the initial discharge voltage on the discharge current (current rate C) in a diagram,

FIG. 4 shows the dependence of the initial voltage on temperature at a discharge current of 1C in a diagram,

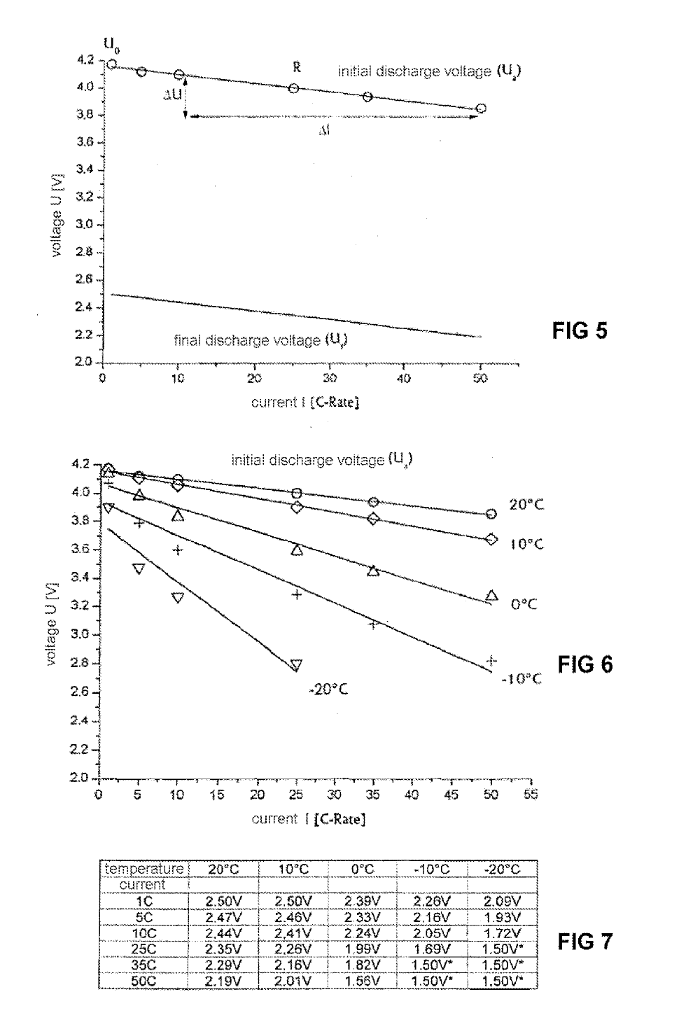

FIG. 5 shows the adaptation of the cutoff limit as a function of the discharge current and in accordance with the initial discharge voltage (Uₐ) in a diagram,

FIG. 6 shows the influence of temperature and of the discharge current on the initial discharge voltage (Uₐ) in a diagram, and

FIG. 7 shows the respective calculated dynamic cutoff limits, allowing for temperature and discharge current, in a table.

In the embodiment according to the invention of an energy supply device, which is shown in FIG. 1, a power source embodied, for example, as a fuel cell, lead storage battery, nickel-zinc battery, double layer capacitor, lithium-air battery, zinc-air battery, aluminum-air battery, nickel-metal hydride battery or lithium-ion battery and referred to below for short as battery 1 is connected to a load 3 via a controllable switch 2. The switch 2 is controlled by a monitoring device 4, which, inter alia, contains a comparator 5. On the comparator 5, one input is connected to one pole of the battery 1 in order to measure the battery voltage U relative to ground 6, while a cutoff limit characterizing the final discharge voltage (Uₛ) is applied to the other terminal of the comparator 5. The cutoff limit is made available by an interpolation device 7, which is connected, in turn, to the output of a memory 8. Stored in the memory 8 is a table, which contains respective limits associated with particular combinations of temperature and discharge current. If a temperature measured at the battery 1 by means of a temperature measuring device 9 and a discharge current measured by means of a current measuring device 10 is then fed to the memory 8, the latter outputs a corresponding cutoff limit if corresponding temperature and discharge current values have been stored in the memory 8. In this case, the associated cutoff limit is then transmitted unchanged to the comparator 5 by means of the interpolation unit 7. However, if the measured values for temperature and discharge current do not correspond to those contained in the table, the two values which are closest thereto are read out of the table and used in the interpolation unit 7, by means of linear interpolation for example, to determine the appropriate cutoff limit, which is transmitted to the comparator 5.

If the voltage U at the battery 1 is higher than the cutoff limit determined (in accordance with the actual value of the voltage Uₛ), the switch 2 is closed and the load 3 is supplied with power. Conversely, i.e. if the voltage U at the battery 1 is equal to the cutoff limit or drops below it, the switch 2 is opened and the load is thus decoupled from the battery in order to prevent a deep discharge of the battery 1.

In FIG. 2, the typical curve profile during the discharge of a battery is divided into the 3 phases explained at the outset.

The beginning of current loading (phase 1) is accordingly characterized by a virtually instantaneous voltage dip. This voltage dip ΔU is defined by the change in the load current ΔI and the internal resistance Rᵢ of the power source as defined by Ohm's Law.

The constant voltage profile with virtually continuous loading (phase 2) is characterized by a continuous voltage drop with a greater or lesser fall in the cell voltages, depending on the cell size, cell chemistry and loading of the cell (battery).

The voltage dip at the end of the discharge phase (phase 3), which characterizes the discharge profile, is due to the fact that the electrochemical starting materials (electrolyte, active material of the anode and cathode) have been largely converted during discharge by the electrochemical reaction typical of the cell. Owing to the exhaustion of the starting materials, the voltage drop increases significantly in comparison with phase 2. The voltage across the cell collapses relatively quickly. This phase defines the lowest limit of cell discharge, generally known as the cutoff voltage or final discharge voltage (Uₛ). An excessive discharge below the final discharge voltage is considered to be a deep discharge and can lead to increased aging and a loss of capacity due to the high loading of the active reaction material.

At low temperatures and high discharge voltages, the battery voltage U is only just above the final discharge voltage Uₛ (cutoff limit) owing to the large voltage drop at the start of discharge, and this severely limits the power that can be drawn. The dependence of the voltage U on the discharge current I (C rate) and on temperature τ are shown in FIGS. 3 and 4, wherein U₀ denotes the no-load voltage of the battery, Uₐ denotes the initial discharge voltage thereof, R denotes the internal resistance thereof, ΔU denotes a change in voltage, ΔI denotes a change in current and Uₛ denotes the final discharge voltage. As is known, the C rate is obtained from the nominal capacity of the battery (e.g. 200 Ah) per unit time (1 h), in the present example therefore 1C=200 A.

According to the invention, a “dynamic” cutoff limit as a function of the instantaneous operating temperature and of the discharge current is provided. Introducing this dynamic variation into the cutoff limit for the power source according to operating conditions makes it possible to draw significantly more power from the power source, especially at low temperatures and high current loads, without the need to increase its capacity, thereby making it possible to achieve a significant saving in terms of weight-related costs on hybrid or electric vehicles, for example, without imposing more severe aging on the power source (especially when this is a battery).

The internal resistance of a cell, taken as an example, of any desired power source is dependent on the temperature of the cell. Depending on the electrochemical structure of the cells, the internal resistance R increases to a greater or lesser extent at low temperatures. As a result, the internal resistance causes a significantly larger voltage drop at low temperatures and at the start of discharge than the internal resistance at a nominal temperature of, for example, 20° Celsius. The voltage drop at the start of discharge is defined essentially by the internal resistance R as well as the discharge current I. According to the invention, this large voltage drop at the start of discharge (phase 1) is allowed for by adapting the final discharge voltage (cutoff limit) in accordance with the instantaneous temperature τ of the cell. This adaptation of the final discharge voltage makes a consistent allowance for the increase in internal resistance R without causing higher loading due to increased consumption of the reaction partners in comparison with nominal operating conditions (nominal temperature and nominal current) and associated aging.

A second aspect of the introduction of dynamic variation applies to the load current. Here, allowance is made for the fact that, at relatively high currents and a constant internal resistance, Ohm's Law entails that the battery also has a correspondingly larger voltage drop at the start of discharge. This is clear from FIG. 5. The initial voltage Uₐ exhibits a linear dependence on the discharge current I. In principle, the ratio dU/dI for the slope of the function represents the internal resistance R of the respective type of cell under consideration, wherein, in principle, the point of intersection of this curve with the ordinate (Y axis, I=0) represents the open-circuit voltage U₀ of the battery. Owing to the larger voltage drop, the voltage can be adapted accordingly in a linear manner, as can likewise be seen in FIG. 5.

FIG. 6 illustrates the influence of both variables together. While allowing for both influencing variables, it is possible, in accordance with FIG. 5, to define corresponding profiles of the final discharge voltages for other temperatures too. The family of curves thus obtained (or the corresponding equations) can then be used to determine the final discharge voltage at different discharge currents. In this case, the straight line equation (parabolic equation etc.) defined for a particular temperature can be used, for example, thus ensuring that this influencing variable is also allowed for. At operating temperatures between two specified temperatures, the value can be determined by linear interpolation from the closest straight-line equations, for example. The values thus obtained for a cell taken as an example can be found in FIG. 7. In contrast to the customary measures, the introduction of dynamic variation into the cutoff limit does not lead to additional aging of the cell since the loading of the active material is held constant in relation to the nominal conditions. The dynamic adaptation of the final discharge voltage significantly enhances the discharge performance of the battery, especially at low temperatures, and avoids any increase in the number of cells or capacity of the cells of the battery which might be necessary as a result, and this leads to savings in respect of price, volume and weight. At the same time, provision can be made for the cutoff limit to be determined one single time, at certain time intervals or continuously by external measuring devices or by the monitoring device 4 itself at least from the current intensity and voltage.

1-6. (canceled)

7. A power supply device, comprising:
a power source for providing a voltage;
a monitoring device electrically connected to said power source, said monitoring device being configured for measuring the voltage, a current intensity, and a temperature at said power source when power is being drawn from said power source, and for interrupting a power draw if the voltage drops below a cutoff limit, wherein the cutoff limit depends on the temperature at said power source and on the current intensity.

8. The device according to claim 7, wherein said monitoring device comprises a memory, wherein respective limits associated with certain combinations of temperature and discharge current are stored in tabular form and wherein an appropriate cutoff limit is output when the measured temperature and discharge current values are input.

9. The device according to claim 8, wherein said monitoring device comprises a processing unit configured to interpolate the appropriate cutoff limit in each case from closest values in the table for measured temperature and/or discharge current values that are not in the table.

10. The device according to claim 8, wherein tables in said memory contain cutoff voltages dependent on the voltage at said power source, the discharge current, the temperature and an internal resistance of said power source.

11. The device according to claim 7, wherein said power source is a storage device selected from the group consisting of a lead storage battery, a nickel-zinc battery, a double layer capacitor, a lithium-air battery, a zinc-air battery, an aluminum-air battery, a nickel-metal hydride battery, a lithium-sulfur battery, a lithium-fluorine battery, a sodium-sulfur battery, sodium-nickel chloride batteries, and a lithium-ion battery.

12. The device according to claim 7, wherein said monitoring device is configured to determine the cutoff limit from at least the current intensity and the voltage.
